(19) United States
(12) Patent Application Publication
(10) Pub. No.: US 2016/0133420 A1
(43) Pub. Date: May 12, 2016

(54) CIRCUIT BREAKER WITH ORIENTATION CORRECTING USER INTERFACE SYSTEM

(71) Applicant: General Electric Company, Schenectady, NY (US)

(72) Inventor: Cecil Rivers, JR., West Hartford, CT (US)

(21) Appl. No.: 14/537,062

(22) Filed: Nov. 10, 2014

(51) Int. Cl. H01H 71/04; G06F 3/0484; H01H 71/10

(52) U.S. Cl. CPC H01H 71/04; H01H 71/10; G06F 3/04845; H01H 2071/006

(57) ABSTRACT

A circuit breaker with an orientation correcting user interface system is provided, the circuit breaker for rigid mounting in an enclosure. The orientation correcting user interface system includes a display coupled to the electronic trip unit configured to display information. Also included is a sensor configured to output data related to an orientation of the circuit breaker. Further included is a processing device in operative communication with the sensor and the display, the processing device configured to receive the outputted data from the sensor and compare the data to at least one range stored in the processing device, the processing device configured to change an orientation of the displayed information based on the comparison of the data to the at least one range.

### BACKGROUND OF THE INVENTION

The subject matter disclosed herein relates to circuit breakers and, more particularly to an a circuit breaker with an orientation correcting user interface system, as well as a method of automatically correcting an orientation of a user interface arrangement on a circuit breaker.

Circuit breakers are used to protect equipment from overcurrent situations caused, for example, by short circuits or ground faults in or near such equipment. A circuit breaker may be manually switched from an “ON” condition to an “OFF” condition and vice versa. Additionally, the circuit breaker includes a mechanism that is configured to automatically switch the circuit breaker to an “OFF” condition in response to an undesirable operating situation, such as a short circuit, for example.

Circuit breakers may be installed in different orientations, particularly those of the industrial type. A circuit breaker may be oriented in a substantially vertical, upright orientation. Alternatively, the circuit breaker may be rotated to be installed in an orientation that is substantially horizontal, which may be referred to as “group mounted.” The installation orientation will depend upon the particular application of use.

An electronic trip unit is often included in a circuit breaker to perform a variety of functions. In some cases, the electronic trip unit includes a display in order to display information pertaining to an electrical distribution system, the electronic trip unit and the circuit breaker. This information is visible to a user. Additionally, the electronic trip unit may include a user interface that allows a user to access and adjust parameters on the electronic trip unit. The user interface may be formed of any component arrangement configured to allow a user to physically make inputs to carry out a desired function. The display and user interface are arranged in a predetermined arrangement and are designed for one specific orientation of the circuit breaker. As the circuit breaker is rotated, a user must tilt their head to read the display and may be confused about which buttons of the user interface correspond to the desired functional input. As such, the layout of the display and user interface is not ideal for a user in multiple orientations of the circuit breaker.

### BRIEF DESCRIPTION OF THE INVENTION

According to one aspect of the invention, a circuit breaker with an orientation correcting user interface system is provided, the circuit breaker for rigid mounting in an enclosure. The orientation correcting user interface system includes a display coupled to the electronic trip unit configured to display information. Also included is a sensor configured to output data related to an orientation of the circuit breaker. Further included is a processing device in operative communication with the sensor and the display, the processing device configured to receive the outputted data from the sensor and compare the data to at least one range stored in the processing device, the processing device configured to change an orientation of the displayed information based on the comparison of the data to the at least one range.

According to another aspect of the invention, circuit breaker with an orientation correcting user interface system is provided, the circuit breaker for rigid mounting in an enclosure. The orientation correcting user interface system includes an electronic trip unit. Also included is a user interface comprising a plurality of buttons located on a surface of the electronic trip unit configured to allow a user to adjust at least one parameter of the electronic trip unit, each of the plurality of buttons having a distinct function. Further included is a sensor configured to output data related to an orientation of the circuit breaker. Yet further included is a processing device in operative communication with the sensor and the user interface, the processing device configured to receive the outputted data from the sensor and compare the data to at least one range stored in the processing device, the processing device configured to change an orientation of a user interface based on the comparison of the data to the at least one range, wherein a first button is in a first position when the circuit breaker is in a first orientation and in a second position when the circuit breaker is in a second orientation, the first button providing a first function in the first position and a second, distinct function in the second position, wherein a second button is in the first position when the circuit breaker is in the second orientation, the second button providing the first function upon rotation to the first position.

According to yet another aspect of the invention, a method of automatically correcting an orientation of a user interface arrangement on a circuit breaker is provided. The method includes obtaining output data related to an orientation of the circuit breaker with a sensor. The method also includes communicating the output data to a processing device. The method further includes comparing the output data to at least one predetermined range stored in the processing device. The method yet further includes determining whether the circuit breaker is in a first orientation or a second orientation. The method also includes controlling an orientation of displayed information on a display disposed on the electronic trip unit based on the orientation of the circuit breaker.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of a circuit breaker disposed in a first orientation;

FIG. 2 is a front view of the circuit breaker disposed in a second orientation;

FIG. 3 is a front view of the circuit breaker disposed in a third orientation; and

FIG. 4 is a block diagram of an electronic trip unit of the circuit breaker.

The detailed description explains embodiments of the invention, together with advantages and features, by way of example with reference to the drawings.

### DETAILED DESCRIPTION OF THE INVENTION

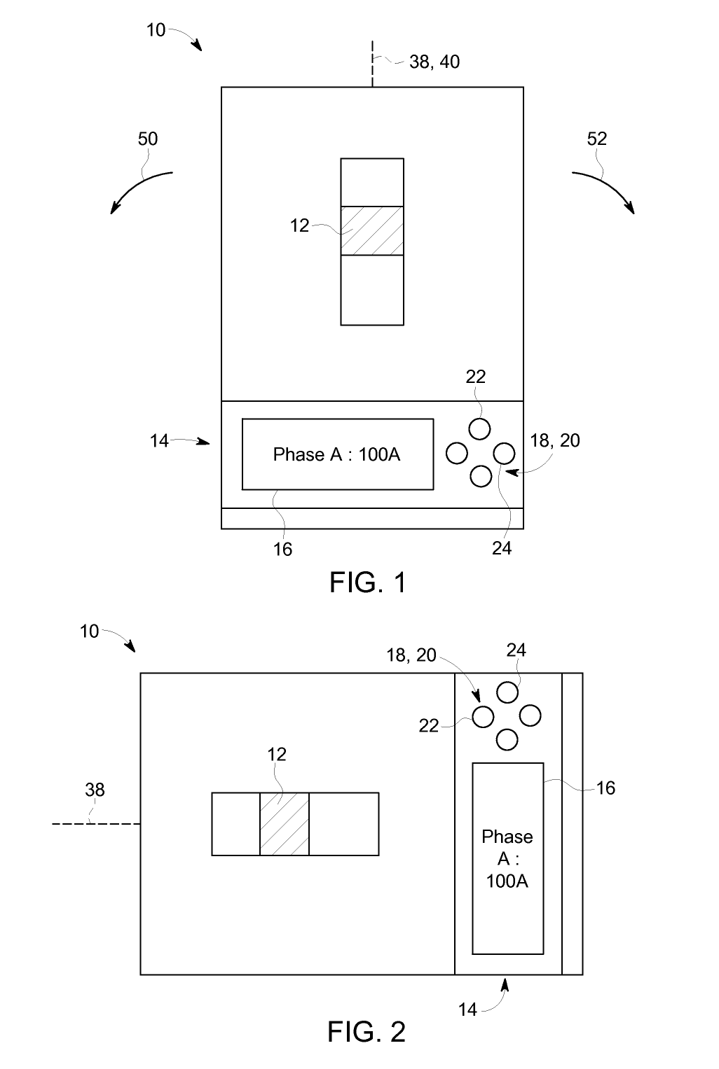

Referring to FIGS. 1-3, a circuit breaker 10 is partially and generically illustrated. The circuit breaker 10 is configured to transfer power from a source to a load. The circuit breaker 10 includes a number of components configured to detect a hazardous or undesirable operating condition and to initiate switching the circuit breaker 10 to a tripped or closed condition. Additionally, manual manipulation of the condition of the circuit breaker 10 is facilitated with a handle 12 that may be actuated by an operator. This gives the operator the ability to turn the circuit breaker 10 “ON” to energize a protected circuit, turn the circuit breaker “OFF” to disconnect the protected circuit breaker, or reset the circuit breaker 10 after a fault. An electronic trip unit 14 that is configured to measure current and voltage supplied to a load and to make a determination whether to open the breaker based on predefined parameters.

At least one visible user element, also referred to herein as a user interface arrangement, is disposed on an outer surface of the electronic trip unit 14. The visible user element may be any element that allows a user to view information or to interact with the circuit breaker 10 in some manner. The information may be provided in the form of text and/or graphics. In one embodiment, the visible user element is a display 16 in the form of a liquid crystal display (LCD), light emitting diode (LED) display, or the like. The display 16 displays information pertaining an electrical distribution system associated with the circuit breaker 10, the electronic trip unit 14, and the circuit breaker 10 generally. As an example and as shown in the illustrated embodiment, the display 16 may show a current value, but it is to be appreciated that information relating to voltage, faults or the like may be provided to a user via the display 16.

In another embodiment, the visible user element is a user interface 18 that allows a user to access and adjust parameters on the electronic trip unit 14. The user interface may include one or more buttons, levers, knobs, switches, or the like to facilitate interaction between the user and the electronic trip unit 14. In the illustrated exemplary embodiment, a plurality of buttons 20 is provided as the user interface 18. The particular arrangement of the buttons 20 may be referred to as a “D-pad” based on the directional commands that may be input by the user to achieve distinct functions associated with each button. For example, with reference specifically to FIG. 1, a first button 22 is configured to prompt a scroll function in an upward direction, while a second button 24 is configured to prompt a scroll function in a direction to the right. Scrolling may refer to scrolling functionality on the display 16.

As shown, the visible user element comprises the display 16 and the user interface 18, but it is to be understood that either of these elements may be employed alone in some embodiments. It is to be appreciated that the display 16 and the user interface 18 are merely illustrative elements that may be associated with the electronic trip unit 14 as the visible user element(s). As such, alternative elements may be disposed proximate the outer surface of the electronic trip unit 14 to display information to a user or to facilitate user interaction with the electronic trip unit 14.

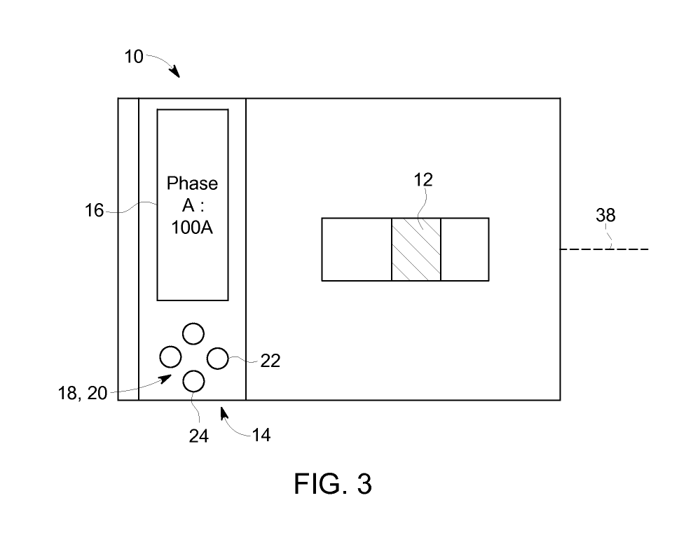

In some instances, the circuit breaker 10 and hence the electronic trip unit 14 are disposed in the substantially vertical orientation of FIG. 1, while in other instances the circuit breaker 10 is disposed in the substantially horizontal orientation of FIG. 2 or 3. The desired orientation of the circuit breaker 10 depends upon the particular application of use. The substantially vertical orientation of FIG. 1 is sometimes referred to as an upright orientation, which is a typical orientation for industrial circuit breakers. The substantially horizontal orientation of FIGS. 2 and 3 is sometimes referred to as a “group-mounted” orientation.

The display 16 is typically programmed to display information in a single orientation that corresponds to a single orientation of the circuit breaker 10. For example, the text and/or graphics shown on the display 16 is oriented in a single, fixed position. Similarly, the plurality of buttons 20 of the user interface 18 is typically programmed to have their respective functions locked in a single orientation that corresponds to a single orientation of the circuit breaker 10. For example, the first button 22 is associated with an upward scrolling command, as described above, regardless of the overall orientation of the circuit breaker. As one can appreciate, if the circuit breaker 10 is rotated from an orientation that corresponds to the designed or programmed orientations of the display 16 and the user interface 18, a user would have to tilt his/her head to comfortably view the text and/or graphics of the display 16 and may be confused about which button corresponds to which command.

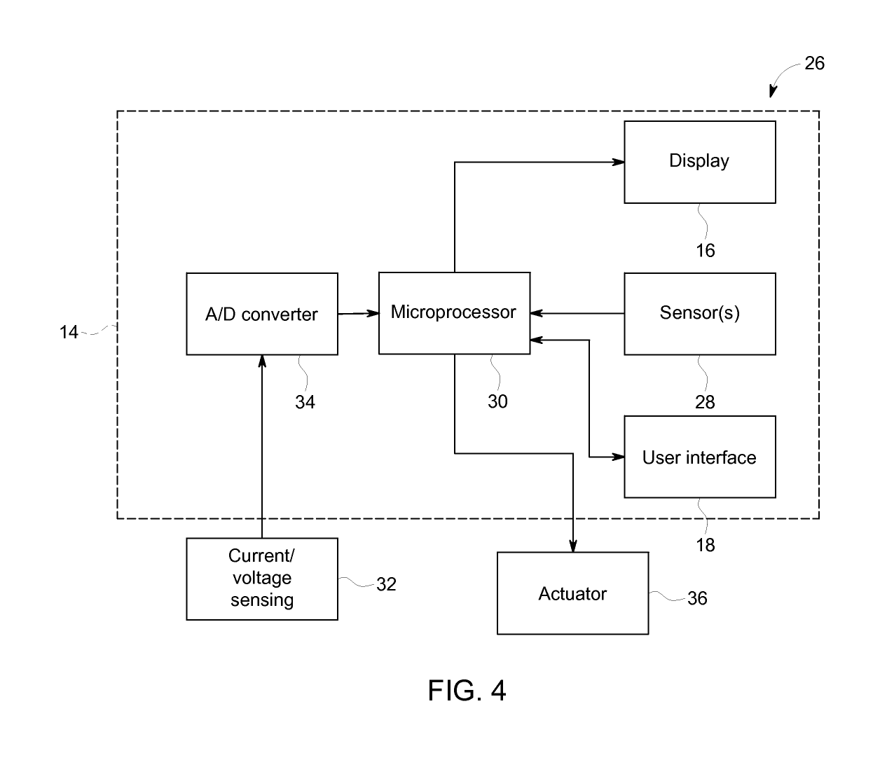

Referring to FIG. 4, with continued reference to FIGS. 1-3, an automatic correcting user interface system 26 is provided to alleviate user difficulties associated with different orientations of the circuit breaker 10. The automatic correcting user interface system 26 generally comprises the circuit breaker 10, the electronic trip unit 14, a sensor 28 and a processing device, such as a microprocessor 30. Other basic components of the circuit breaker 10 are generally illustrated. In particular, current and voltage sensing is performed by component 32, which communicates data to a converter 34, which then relays information to the microprocessor 30. The microprocessor 30 is in communication with an actuator 36 that is configured to switch the circuit breaker 10 between different states.

The sensor 28 may be operatively coupled to the circuit breaker 10 or the electronic trip unit 14. The sensor 28 is any type of sensor configured to detect motion, position, orientation, or the like. Illustrative embodiments of the sensor 28 include an accelerometer, a tilt sensor, a gyroscope, and a motion sensor. Irrespective of the precise type of sensor employed, the sensor 28 is configured to detect certain physical characteristics related to a circuit breaker orientation and to provide an output data with that information. For example, in the case of the accelerometer, the output data relates to a detected acceleration due to gravity. The output data is provided to the microprocessor 30 that is in operative communication with the sensor 28. The operative communication refers to either a wired or wireless transmission of data.

The microprocessor 30 is configured to receive the output data from the sensor 28 and compare the data to at least one range or threshold stored therein. The range or threshold corresponds to one or more orientations of the circuit breaker 10. For example, a first range corresponds to the first, substantially vertical orientation of FIG. 1, while a second range corresponds to the second, substantially horizontal orientation of FIG. 2, and a third range corresponds to the third, substantially horizontal orientation of FIG. 3. As noted above, a threshold value may be sufficient to determine what orientation the circuit breaker 10 is in to a satisfactory degree. The determined orientation of the circuit breaker 10 dictates what orientation the displayed information (e.g., text and graphics) is provided in on the display 16 and what function each of the plurality of buttons 20 of the user interface 18 is associated with. In particular, the text and/or graphics of the display 16 are rotated to the second orientation shown in FIG. 2 or 3 upon determination that the circuit breaker 10 has rotated away from the first orientation of FIG. 1. This is accomplished based on operative communication between the microprocessor 30 and the display 16 and the user interface 18. The microprocessor 30 is configured to control the orientation of the displayed information and the functionality of each of the plurality of buttons 20. In one embodiment, the rotation of the display 16 and/or the user interface is limited to only three discrete orientations of the circuit breaker 10. In such an embodiment, the rotation is limited to a vertical orientation (FIG. 1) of the circuit breaker 10, a first horizontal orientation (FIG. 2) of the circuit breaker 10, and a second horizontal orientation (FIG. 3) of the circuit breaker 10.

For an embodiment having three discrete orientations, such as those illustrated in FIGS. 1-3, a threshold value of output data is sufficient. In particular, the displayed information of the display 16 is in the first orientation (FIG. 1) when a central axis 38 of the circuit breaker 10 is oriented at an angle of less than +/−45 degrees relative to a reference axis 40. In the illustrated embodiment, the reference axis 40 is a substantially vertical axis, but it is to be appreciated that the reference axis 40 may be alternatively located. Conversely, the displayed information of the display 16 is in the second orientation (FIG. 2) when the central axis 38 of the circuit breaker 10 is oriented at an angle of greater than −45 degrees relative to the reference axis 40. Additionally, the displayed information on the display 16 is in the third orientation (FIG. 3) when the central axis 38 of the circuit breaker 10 is oriented at an angle of greater than +45 degrees relative to the reference axis 40.

In the case of the user interface 18, each of the plurality of buttons 20 switches functionality based on the orientation of the circuit breaker 10. Specifically, by way of non-limiting example, in the first orientation (FIG. 1) the first button 22 is configured to provide the upward scrolling function described above, but in the second orientation (FIG. 2) the first button 22 is configured to provide scrolling in a direction to the left. Similarly, the second button 24 is configured to provide scrolling to the right in the first orientation (FIG. 1), but in the second orientation (FIG. 2) the second button 24 is configured to provide scrolling in an upward direction. Switching functionality of the buttons is achieved by rotating the circuit breaker from the first orientation (FIG. 1) in a direction 50 past a threshold angle, such as −45 degrees, to the second orientation (FIG. 2). Additionally, upon rotation of the circuit breaker in a direction 52 to the third orientation (FIG. 3) that is defined by a predetermined threshold angle, such as +45 degrees, the first button 22 is configured to switch from providing the upward scrolling function to a function that provides scrolling to the right. Similarly, the second button 24 switches from providing the scrolling to the right to a function that provides downward scrolling. The modification of scrolling function may be generally described as a first button being in a first position when the circuit breaker is in a first orientation and in a second position when the circuit breaker is in a second orientation, the first button providing a first function in the first position and a second, distinct function in the second position. Meanwhile, a second button is in the first position when the circuit breaker is in the second orientation, the second button providing the first function upon rotation to the first position. In other words, a different button replaces the functionality of another button that previously was oriented in the position that the new button is now positioned in. This directional conversion of scrolling functions results in a more intuitive command for a user regardless of the orientation of the circuit breaker 10 and hence the electronic trip unit 14.

Although described above as a 45 degree threshold value, it is to be understood that threshold values other than 45 degrees may be employed. The two-orientation embodiment described above is merely illustrative and more than two orientations may be provided by including multiple ranges stored in the microprocessor 30 for comparison with the output data from the sensor 28. Furthermore, it is contemplated that with small enough ranges, the rotation of the displayed information is continuously rotated over an entire range of rotation of the circuit breaker 10.

Advantageously, a user will never have to tilt his/her head or reorient his line of vision to read the display 16 if the circuit breaker 10. Additionally, functions associated with the user interface 18 will always be intuitive and will never force a user to guess which buttons to press regardless of the circuit breaker orientation, thereby enhancing the ease of use of the electronic trip unit 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A circuit breaker with an orientation correcting user interface system, the circuit breaker for rigid mounting in an enclosure and comprising:
an electronic trip unit;
a display coupled to the electronic trip unit configured to display information;
a sensor configured to output data related to an orientation of the circuit breaker; and
a processing device in operative communication with the sensor and the display, the processing device configured to receive the outputted data from the sensor and compare the data to at least one range stored in the processing device, the processing device configured to change an orientation of the displayed information based on the comparison of the data to the at least one range.

2. The orientation correcting user interface system of claim 1, wherein the displayed information comprises at least one of text and graphics.

3. The orientation correcting user interface system of claim 1, wherein the displayed information is rotated upon rotation of the circuit breaker.

4. The orientation correcting user interface system of claim 1, wherein the displayed information is in a first orientation when a central axis of the circuit breaker is oriented at an angle of less than 45 degrees relative to a reference axis and in a second orientation when the central axis of the circuit breaker is oriented at an angle of greater than 45 degrees relative to the reference axis.

5. The orientation correcting user interface system of claim 1, wherein the sensor is operatively coupled to the circuit breaker.

6. The orientation correcting user interface system of claim 1, wherein the sensor is operatively coupled to the electronic trip unit.

7. The orientation correcting user interface system of claim 1, wherein the sensor is at least one of an accelerometer, a tilt sensor, a gyroscope, and a motion sensor.

8. The orientation correcting user interface system of claim 1, wherein the orientation of the circuit breaker consists of a first orientation, a second orientation and a third orientation, the orientation of the displayed information corresponding to the orientation of the circuit breaker.

9. The orientation correcting user interface system of claim 8, wherein the first orientation is a vertical position, the second orientation is a first horizontal position and the third orientation is a second horizontal position.

10. The orientation correcting user interface system of claim 1, wherein the display is a LCD.

11. A circuit breaker with an orientation correcting user interface system, the circuit breaker for rigid mounting in an enclosure and comprising:
an electronic trip unit;
a user interface comprising a plurality of buttons located on a surface of the electronic trip unit configured to allow a user to adjust at least one parameter of the electronic trip unit, each of the plurality of buttons having a distinct function;
a sensor configured to output data related to an orientation of the circuit breaker; and
a processing device in operative communication with the sensor and the user interface, the processing device configured to receive the outputted data from the sensor and compare the data to at least one range stored in the processing device, the processing device configured to change an orientation of a user interface based on the comparison of the data to the at least one range, wherein a first button is in a first position when the circuit breaker is in a first orientation and in a second position when the circuit breaker is in a second orientation, the first button providing a first function in the first position and a second, distinct function in the second position, wherein a second button is in the first position when the circuit breaker is in the second orientation, the second button providing the first function upon rotation to the first position.

12. The orientation correcting user interface system of claim 11, wherein each of the plurality of buttons provides an initial function when a central axis of the circuit breaker is oriented at an angle of less than 45 degrees relative to a reference axis and provides a first alternate function when the central axis of the circuit breaker is oriented at an angle of greater than 45 degrees relative to the reference axis.

13. The orientation correcting user interface system of claim 12, wherein each of the plurality of buttons provides a second alternate function when the central axis of the circuit breaker is oriented at an angle of greater than −45 degrees relative to the reference axis.

14. The orientation correcting user interface system of claim 11, wherein the sensor is operatively coupled to the circuit breaker.

15. The orientation correcting user interface system of claim 11, wherein the sensor is operatively coupled to the electronic trip unit.

16. The orientation correcting user interface system of claim 11, wherein the sensor comprises at least one of an accelerometer, a tilt sensor, a gyroscope, and a motion sensor.

17. A method of automatically correcting an orientation of a user interface arrangement on a circuit breaker for rigid mounting in an enclosure, the method comprising:
obtaining output data related to an orientation of the circuit breaker with a sensor;
communicating the output data to a processing device;
comparing the output data to at least one predetermined range stored in the processing device;
determining whether the circuit breaker is in a first orientation or a second orientation; and
controlling an orientation of displayed information on a display disposed on the electronic trip unit based on the orientation of the circuit breaker.

18. The method of claim 17, further comprising controlling the orientation of a plurality of buttons on a user interface of the electronic trip unit based on the orientation of the circuit breaker.
